(19) United States
(12) Patent Application Publication
(10) Pub. No.: US 2022/0414472 A1
(43) Pub. Date: Dec. 29, 2022

(54) Computer-Implemented Method, System, and Non-Transitory Computer-Readable Storage Medium for Inferring Audience's Evaluation of Performance Data

(71) Applicant: Yamaha Corporation, Hamamatsu-shi (JP)

(72) Inventor: Akira MAEZAWA, Hamamatsu-shi (JP)

(21) Appl. No.: 17/901,129

(22) Filed: Sep. 1, 2022

Related U.S. Application Data
(63) Continuation of application No. PCT/JP2021/003783, filed on Feb. 2, 2021.

(30) Foreign Application Priority Data
Mar. 4, 2020 (JP) 2020-036990

(51) Int. Cl. G06N 3/08; G10H 1/00; G06T 7/246

(52) U.S. Cl. CPC G06N 3/08; G10H 1/0008; G06T 7/246; G10H 2210/091; G06T 2207/30196; G06T 2207/10016

(57) ABSTRACT

A computer-implemented method includes obtaining a trained model trained to store a relationship between first performance data and first evaluation data. The first performance data indicates a performance performed by a performer. The first evaluation data indicates a first evaluation of the performance. The first evaluation has been made by an audience who has received the performance. The method also includes obtaining second performance data. The method also includes processing the second performance data using the trained model to make an inference of a second evaluation of the second performance data. The method also includes outputting second evaluation data indicating the inference of the second evaluation.

### CROSS-REFERENCE TO RELATED APPLICATIONS

The present application is a continuation application of International Application No. PCT/JP2021/003783, filed Feb. 2, 2021, which claims priority to Japanese Patent Application No. 2020-036990, filed Mar. 4, 2020. The contents of these applications are incorporated herein by reference in their entirety.

### BACKGROUND OF THE INVENTION

### Field of the Invention

The embodiments disclosed herein relate to a computer-implemented method, a system, and a non-transitory computer-readable recording medium for inferring an audience's evaluation of performance data.

### Background

JP3678135B2 discloses a performance evaluation apparatus that evaluates a performance operation made by a user. Specifically, JP3678135B2 discloses such a technique that selects a part of an entirety of a music performance and evaluates the part as a performance operation.

The purpose behind the technique disclosed in JP3678135B2 is to evaluate the accuracy of a performance performed by a user, instead of inferring the degree to which a performance is evaluated by an audience. In order for a user to appropriately improve the user's performance, it is necessary for the user to make an inference of an evaluation of the performance in advance.

The present development has been made in view of the above-described circumstances. An example object of the present disclosure is to provide a computer-implemented method, a system, and a non-transitory computer-readable recording medium for appropriately inferring an evaluation of performance data.

### SUMMARY

One aspect is a computer-implemented method that includes obtaining a trained model trained to store a relationship between first performance data and first evaluation data. The first performance data indicates a performance performed by a performer. The first evaluation data indicates a first evaluation of the performance. The first evaluation has been made by an audience who has received the performance. The method also includes obtaining second performance data. The method also includes processing the second performance data using the trained model to make an inference of a second evaluation of the second performance data. The method also includes outputting second evaluation data indicating the inference of the second evaluation.

Another aspect is a system that includes a memory and at least one processor. The memory stores a program. The at least one processor is configured to execute the program stored in the memory to obtain a trained model trained to store a relationship between first performance data and first evaluation data. The first performance data indicates a performance performed by a performer, the first evaluation data indicating a first evaluation of the performance. The first evaluation has been made by an audience who has received the performance. The at least one processor is also configured to execute the program to obtain second performance data. The at least one processor is also configured to execute the program to process the second performance data using the trained model to make an inference of a second evaluation of the second performance data. The at least one processor is also configured to execute the program to output second evaluation data indicating the inference of the second evaluation.

Another aspect is a non-transitory computer-readable recording medium storing a program that, when executed by at least one computer, cause the at least one computer to perform a method. The method includes obtaining a trained model trained to store a relationship between first performance data and first evaluation data. The first performance data indicates a performance performed by a performer, the first evaluation data indicating a first evaluation of the performance. The first evaluation has been made by an audience who has received the performance. The method also includes obtaining second performance data. The method also includes processing the second performance data using the trained model to make an inference of a second evaluation of the second performance data. The method also includes outputting second evaluation data indicating the inference of the second evaluation.

The above-described aspect of the present disclosure ensures that an evaluation of performance data is appropriately inferred.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the following figures.

FIG. 1 is a diagram illustrating an overall configuration of an information processing system according to an embodiment of the present disclosure.

FIG. 2 is a block diagram illustrating a hardware configuration of an information processing apparatus according to the embodiment of the present disclosure.

FIG. 3 is a block diagram illustrating a hardware configuration of a training server according to the embodiment of the present disclosure.

FIG. 4 is a block diagram illustrating a functional configuration of the information processing system according to the embodiment of the present disclosure.

FIG. 5 is a sequence diagram illustrating machine-learning processing according to the embodiment of the present disclosure.

FIG. 6 is a sequence diagram illustrating inference presentation processing according to the embodiment of the present disclosure.

### DETAILED DESCRIPTION

The present development is applicable to a method, a system, and a non-transitory computer-readable recording medium for inferring an audience's evaluation of performance data.

Embodiments of the present disclosure will be described below by referring to the accompanying drawings. It is to be noted that each of the embodiments described below is a non-limiting exemplary configuration that embodies the present disclosure. It is also to be noted that each of the embodiments described below can be modified or changed in a manner suitable for the configuration of an apparatus and/or a device to which the present disclosure is applied and/or suitable for various conditions. It is also to be noted that not all elements of the combinations of elements described in the embodiments described below are essential for embodying the present disclosure; one or some of the elements can be omitted as deemed necessary. That is, the scope of the present disclosure will not be limited by the configurations described in the embodiments described below. It is also to be noted that the plurality of configurations described in the embodiments described below may be combined to form another configuration insofar as no contradiction occurs.

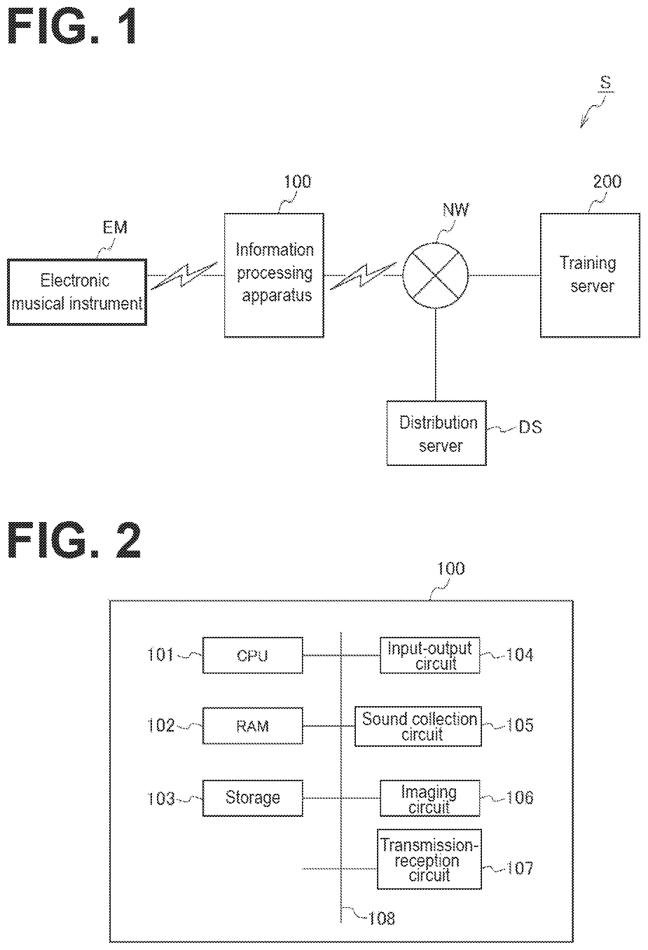

FIG. 1 is a diagram illustrating an overall configuration of an information processing system S according to an embodiment of the present disclosure. As illustrated in FIG. 1, the information processing system S according to this embodiment includes an information processing apparatus 100 and a training server 200. The information processing apparatus 100 and the training server 200 are communicable with each other via a network NW. A distribution server DS, described later, may be connected to the network NW.

The information processing apparatus 100 is an information terminal used by a user. For example, the information processing apparatus 100 can be a personal device such as a tablet terminal, a smartphone, and a personal computer (PC). The information processing apparatus 100 may be connected to an electronic musical instrument EM, described later, in a wireless or wired manner.

The training server 200 is a cloud server connected to the network NW. The training server 200 trains a trained model M, described later, and supplies the trained model M to another apparatus or device such as the information processing apparatus 100. The training server 200 will not be limited to a cloud server; the training server 200 may be a server on a local network. The functions of the training server 200 according to this embodiment may be implemented by a cloud server cooperating with a server on a local network.

In the information processing system S according to this embodiment, by inputting inference-target performance data A into a trained model M, an evaluation of the performance data A is inferred. The performance data A indicates a performance performed by a performer. The trained model M is a trained model that has been trained by machine learning to store a relationship between performance data A and evaluation data B. The evaluation data B indicates an evaluation of performance.

FIG. 2 is a block diagram illustrating a hardware configuration of the information processing apparatus 100. As illustrated in FIG. 2, the information processing apparatus 100 includes a central processing unit (CPU) 101, a random access memory (RAM) 102, a storage 103, an input-output circuit 104, a sound collection circuit 105, an imaging circuit 106, a transmission-reception circuit 107, and a bus 108.

The CPU 101 is a processing circuit that performs various calculations and/or computations and/or computations in the information processing apparatus 100. The RAM 102 is a volatile recording medium and stores setting values used by the CPU 101. The RAM 102 also functions as a working memory in which various programs are developed. The storage 103 is a non-volatile recording medium and stores various programs and data used by the CPU 101.

The input-output circuit 104 is an element (user interface) that receives operations made by a user with respect to the information processing apparatus 100. The input-output circuit 104 also displays various kinds of information. For example, the input-output circuit 104 can be a touch panel.

The sound collection circuit 105 is an element that converts collected sound into an electric signal and supplies the electric signal to the CPU 101. For example, the sound collection circuit 105 can be a microphone. The sound collection circuit 105 may be built in the information processing apparatus 100 or may be connected to the information processing apparatus 100 via an interface not illustrated.

The imaging circuit 106 is an element that converts a captured image into an electric signal and supplies the electric signal to the CPU 101. For example, the imaging circuit 106 can be a digital camera. The imaging circuit 106 may be built in the information processing apparatus 100 or may be connected to the information processing apparatus 100 via an interface not illustrated.

The transmission-reception circuit 107 is an element that transmits and receives data to and from other apparatus and/or devices such as the training server 200. The transmission-reception circuit 107 is connectable to the electronic musical instrument EM, which is used by the user when the user plays music, so as to transmit and receive data to and from the electronic musical instrument EM. The transmission-reception circuit 107 may include a plurality of modules (for example, near-field communication modules such as a Bluetooth (registered trademark) module and a Wi-Fi (registered trademark) module).

The bus 108 is a signal transmission path that connects the above-described hardware elements of the information processing apparatus 100 to each other.

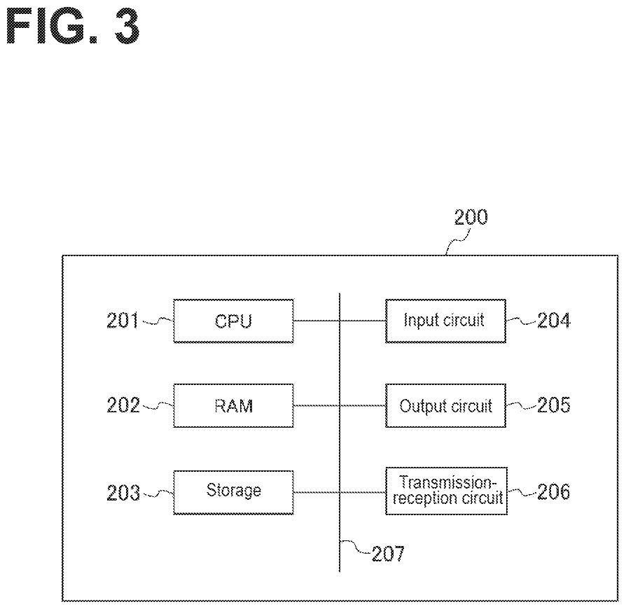

FIG. 3 is a block diagram illustrating a hardware configuration of the training server 200. As illustrated in FIG. 3, the training server 200 includes a CPU 201, a RAM 202, a storage 203, an input circuit 204, an output circuit 205, a transmission-reception circuit 206, and a bus 207.

The CPU 201 is a processing circuit that performs various calculations and/or computations in the training server 200. The RAM 202 is a volatile recording medium and stores setting values used by the CPU 201. The RAM 202 also functions as a working memory in which various programs are developed. The storage 203 is a non-volatile recording medium and stores various programs and data used by the CPU 201.

The input circuit 204 is an element that receives an operation made with respect to the training server 200. For example, the input circuit 204 receives an input signal from a keyboard and a mouse connected to the training server 200.

The output circuit 205 is an element that displays various kinds of information, and outputs a video signal to, for example, a liquid-crystal display connected to the training server 200.

The transmission-reception circuit 206 is an element that transmits and receives data to and from another apparatus or device such as the information processing apparatus 100. For example, the transmission-reception circuit 206 can be a network card (NIC).

The bus 207 is a signal transmission path that connects the above-described hardware elements of the training server 200 to each other.

The CPU 101 or 202 of the device 100 or 200 reads a program stored in the storage 103 or 203 into the RAM 102 or 201, and executes the program. By executing the program, the following functional blocks (such as control circuits 150 and 250) and various processes according to this embodiment are implemented. It is to be noted that each CPU is not limited to a typical CPU; each CPU may be a digital signal processor (DSP), an inference processor, or a combination of two or more of these processors. It is also to be noted that the various processes according to this embodiment may be implemented by executing programs using at least one processor such as a CPU, a DSP, an inference processor, and a graphics processing unit (GPU).

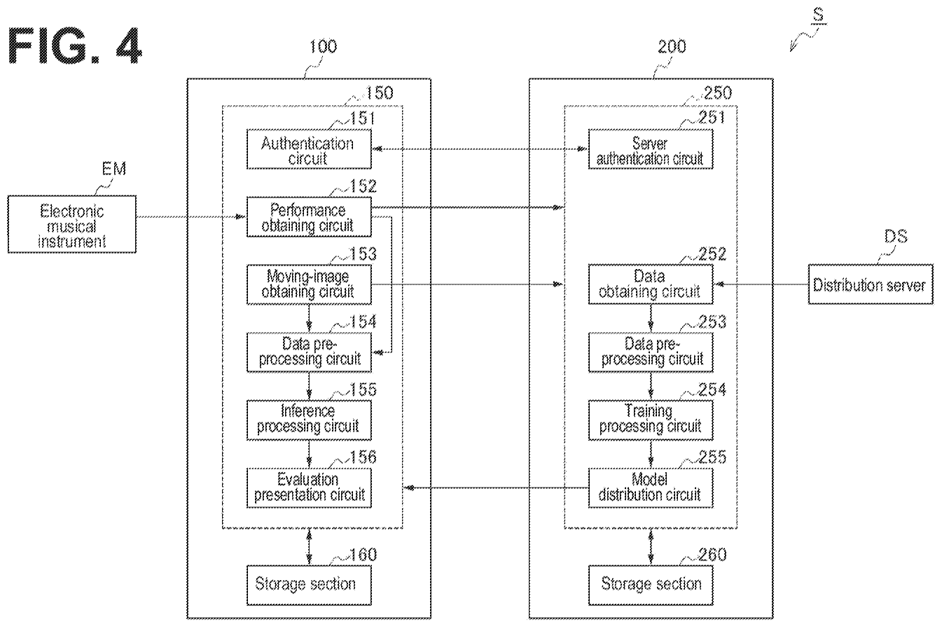

FIG. 4 is a block diagram illustrating a functional configuration of the information processing system S according to this embodiment of the present disclosure.

The training server 200 includes a control section 250 and a storage section 260. The control section 250 is a functional block that integrally controls the operation of the training server 200. The storage section 260 is made up of the RAM 202 and the storage 203, and stores various kinds of information used by the control section 250 (in particular, stores the performance data A and the evaluation data B). The control section 250 includes sub functional blocks including a server authentication circuit 251, a data obtaining circuit 252, a data pre-processing circuit 253, a training processing circuit 254, and a model distribution circuit 255.

The server authentication circuit 251 is a functional block that cooperates with the information processing apparatus 100 (authentication circuit 151) to authenticate a user. The server authentication circuit 251 determines whether authentication data supplied from the information processing apparatus 100 matches authentication data stored in the storage section 260. Then, the server authentication circuit 251 transmits an authentication result (permission or rejection) to the information processing apparatus 100.

The data obtaining circuit 252 is a functional block that receives distribution data from the external distribution server DS via the network NW to obtain performance data A and evaluation data B. For example, the distribution server DS can be a server that distributes distribution data that may be a moving image such as a live moving image that includes video and sound. The distribution data includes data indicating a performer's performance, examples of such data including video data (for example, moving image data), sound data (for example, audio data), and operation data (for example, MIDI data). The distribution data also includes subjective data associated with a performance. The subjective data is an evaluation value given to a performer's performance by a viewer viewing the performance. The subjective data is correlated with the moving image in a time series manner. For example, the evaluation value indicated by the evaluation data may be attached with a point of time corresponding to a part of the moving image, or may be attached with a serial number (frame number) of a part of the moving image. The moving image and the subjective data may be integrally formed. It is preferable that the distribution data includes operation data such as MIDI data indicating a performance operation made by a performer during the performer's performance. The operation data may include a pedal operation of an electronic piano and/or an effector operation of an electric guitar.

The data obtaining circuit 252 obtains performance data A by dividing, in a time series manner, video data and sound data included in received distribution data into a plurality of performance pieces. Then, the data obtaining circuit 252 stores the performance data A in the storage section 260. The data obtaining circuit 252 may divide the video data and the sound data into performance pieces each corresponding to a phrase indicated by a break in the performance. The data obtaining circuit 252 may also divide the video data and the sound data into performance pieces each corresponding to a motif of the performance. The data obtaining circuit 252 may also divide the video data and the sound data into performance pieces each corresponding to a chord pattern.

It is to be noted that the performance data A may include operation data divided in a time-series manner, instead of or in addition to sound data divided in a time-series manner. That is, the performance data A includes one or both of: sound data indicating sound generated by a performance; and operation data generated based on a performance using the electronic musical instrument EM.

The data obtaining circuit 252 also obtains evaluation data B based on the subjective data and the evaluation time included in the received distribution data. The evaluation data B includes evaluation pieces each indicating an evaluation of each divided performance piece. Then, the data obtaining circuit 252 stores the evaluation data B in the storage section 260. The evaluation data B is data indicating a time-series evaluation transition of the time-series performance data A. This data may include a point of time of a performance piece corresponding to an evaluation piece included in the evaluation data B. The data may also include a serial number corresponding to a performance piece and an evaluation piece. The data may also be such that an evaluation piece is embedded in the corresponding performance piece. The data obtaining circuit 252 stores the obtained performance data A and the obtained evaluation data B in the storage section 260.

The data pre-processing circuit 253 is a functional block that pre-processes the performance data A and the evaluation data B stored in the storage section 260. For example, the data pre-processing circuit 253 performs scaling with respect to the performance data A and the evaluation data B to change the performance data A and the evaluation data B into a format suitable for training (machine learning) of the trained model M.

The training processing circuit 254 is a functional block that trains the trained model M by using the pre-processed performance data A as input data and using the pre-processed evaluation data B as teaching data. The trained model M according to this embodiment may be any machine trained model. For example, the trained model M can be a recurrent neural network (RNN) adapted to time-series data and a derivative of the RNN (for example, long short-term memory (LSTM) or gated recurrent unit (GRU)). The trained model M may also be implemented based on an attention-based algorithm.

The model distribution circuit 255 is a functional block that supplies the trained model M trained by the training processing circuit 254 to the information processing apparatus 100.

The information processing apparatus 100 includes a control section 150 and a storage section 160. The control section 150 is a functional block that integrally controls the operation of the information processing apparatus 100. The storage section 160 is made up of the RAM 102 and the storage 103, and stores various kinds of information used by the control section 150. The control section 150 includes sub-functional blocks including the authentication circuit 151, a performance obtaining circuit 152, a moving-image obtaining circuit 153, a data pre-processing circuit 154, an inference processing circuit 155, and an evaluation presentation circuit 156.

The authentication circuit 151 is a functional block that cooperates with the training server 200 (server authentication circuit 251) to authenticate a user. The authentication circuit 151 transmits, to the training server 200, authentication data input by the user using the input-output circuit 104, examples of such authentication data including a user identifier and a password. Then, the authentication circuit 151 permits or rejects access of the user based on an authentication result received from the training server 200. The authentication circuit 151 is capable of suppling the user identifier of the authenticated user (access-permitted user) to other functional blocks.

The performance obtaining circuit 152 is a functional block that obtains one or both of sound data and operation data that indicate the user's performance. Each of the sound data and the operation data is data (sound characteristic data) that indicates characteristics (for example, sound generation time and pitch) of a plurality of sounds included in a musical piece associated with a performance. The sound characteristic data is a kind of high-dimensional time-series data representing a performance performed by a user. The performance obtaining circuit 152 may obtain the sound data based on an electric signal generated by the sound collection circuit 105 that has collected sound of the user's performance. The operation data obtained by the performance obtaining circuit 152 may be operation data generated based on the user's performance using the electronic musical instrument EM. The performance obtaining circuit 152 may obtain such operation data from the electronic musical instrument EM via the transmission-reception section 107. For example, the electronic musical instrument EM can be: an electronic keyboard instrument such as an electronic piano; an electronic stringed instrument such as an electric guitar; or an electronic wind instrument such as a wind synthesizer. The performance obtaining circuit 152 supplies the obtained sound characteristic data to the data pre-processing circuit 154. It is to be noted that the performance obtaining circuit 152 may also add the user identifier supplied from the authentication circuit 151 to the sound characteristic data, and transmit the sound characteristic data to the training server 200.

The moving-image obtaining circuit 153 is a functional block that obtains video data indicating a user's performance. The video data is motion data indicating features of a motion of the user (performer) in the performance, and is a kind of high-dimensional time-series data representing a performance performed by a user. The moving-image obtaining circuit 153 may obtain the motion data based on an electric signal generated by the imaging circuit 106 imaging the user who is performing the performance. For example, the motion data can be data obtained by obtaining a skeleton of the user in a time series manner. The moving-image obtaining circuit 153 supplies the obtained video data to the data pre-processing circuit 154. It is to be noted that the moving-image obtaining circuit 153 may also add the user identifier supplied from the authentication circuit 151 to the video data, and transmit the video data to the training server 200.

The data pre-processing circuit 154 is a functional block that pre-processes the performance data A including the sound characteristic data supplied from the performance obtaining circuit 152 and the video data supplied from the moving-image obtaining circuit 153. For example, the data pre-processing circuit 154 performs scaling with respect to the performance data A to change the performance data A into a format suitable for inferencing using the trained model M.

The inference processing circuit 155 is a functional block that infers evaluation data B. The evaluation data B indicates an evaluation of the performance data A. The inference processing circuit 155 infers the evaluation data B by inputting, as input data, the pre-processed performance data A into the trained model M trained by the training processing circuit 254. As described above, the evaluation data B includes evaluation pieces each indicating an evaluation of a corresponding one of the plurality of performance pieces included in the performance data A.

The evaluation presentation circuit 156 is a functional block that presents the evaluation data B inferred by the inference processing circuit 155 to the user. For example, the evaluation presentation circuit 156 causes the input-output circuit 104 to display, in a time-series manner, the evaluations of the plurality of performance pieces included in the performance data A. It is to be noted that the evaluation presentation circuit 156 may audibly or tactually present the evaluation data B to the user, instead of or in addition to visually presenting the evaluation data B to the user. It is also to be noted that the evaluation presentation circuit 156 may display the evaluations on a display of another apparatus or device, such as the electronic musical instrument EM.

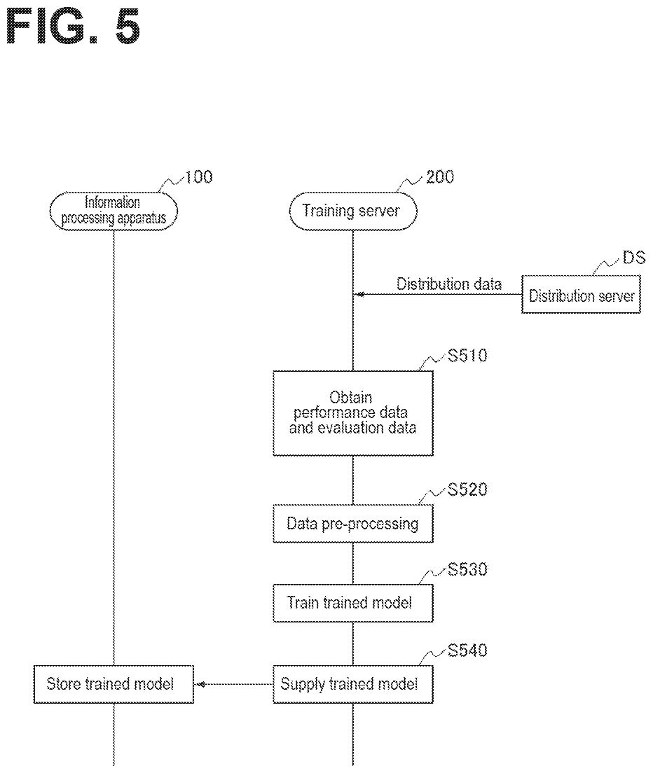

FIG. 5 is a sequence diagram illustrating machine-learning processing performed by the information processing system S according to this embodiment of the present disclosure. The machine-learning processing according to this embodiment is performed in the training server 200. It is to be noted that the machine-learning processing according to this embodiment may be performed periodically or may be performed in response to a request from the information processing apparatus 100 based on a user's instruction.

At step S510, the data obtaining circuit 252 obtains performance data A and evaluation data B based on distribution data received from the distribution servers DS. Then, the data obtaining circuit 252 stores the obtained performance data A and the obtained evaluation data B in the storage section 260. It is to be noted that the distribution data may be obtained in advance by the data obtaining circuit 252 and stored in the storage section 260, or may be obtained by the data obtaining circuit 252 at this step.

At step S520, the data processing circuit 253 reads a dataset including the performance data A and the evaluation data B stored in the storage section 260, and performs data pre-processing of the dataset.

At step S530, based on the dataset pre-processed at step S520, the training processing circuit 254 trains the trained model M using the performance data A as an input data and the evaluation data B as teaching data. Then, the training processing circuit 254 stores the trained model M in the storage section 260. For example, when the trained model M is a neural network system, the training processing circuit 254 may perform machine learning of the trained model M using a method such as backpropagation.

At step S540, the model distribution circuit 255 supplies the trained model M trained at step S530 to the information processing apparatus 100 via the network NW. The control section 150 of the information processing apparatus 100 stores the received trained model M in the storage section 160.

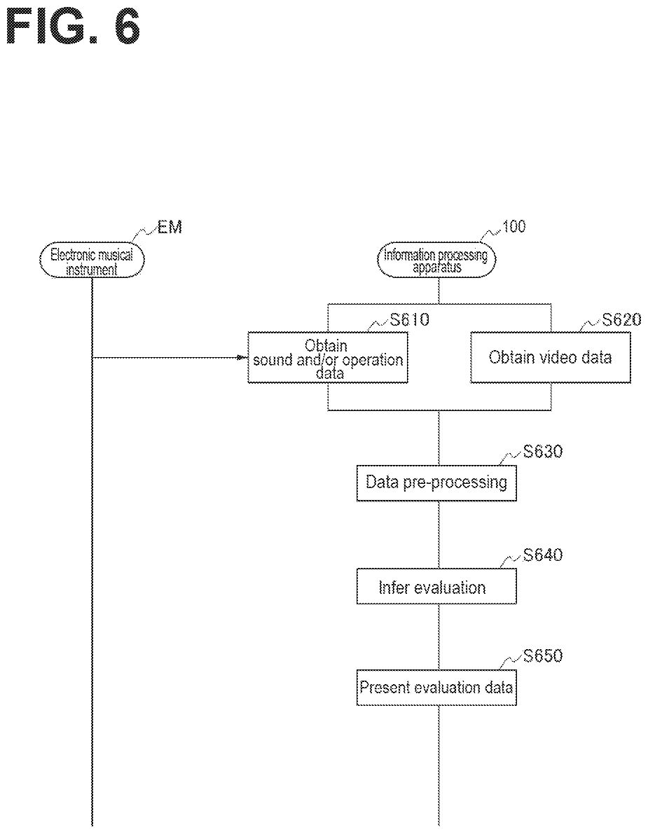

FIG. 6 is a sequence diagram illustrating inference presentation processing in the information processing system S according to this embodiment of the present disclosure. In this embodiment, the information processing apparatus 100 infers an evaluation of each performance piece and visually presents the inferred evaluation to the user.

At step S610, the performance obtaining circuit 152 obtains one or both of sound and operation data (sound characteristic data) from, for example, the electronic musical instrument EM, as described above. Then, the performance obtaining circuit 152 supplies the obtained sound and/or the obtained operation data to the data pre-processing circuit 154.

At step S620, the moving-image obtaining circuit 153 obtains video data, as described above, and supplies the video data to the data pre-processing circuit 154.

At step S630, the data pre-processing circuit 154 pre-processes the performance data A including: the sound characteristic data supplied from the performance obtaining unit 152 at step S610; and the video data supplied from the moving-image obtaining circuit 153 at step S620. Then, the data pre-processing circuit 154 supplies the pre-processed performance data A to the inference processing circuit 155.

At step S640, the inference processing circuit 155 inputs, as input data, the performance data A supplied from the data pre-processing circuit 154 into the trained model M stored in the storage section 160. The trained model M processes the input performance data A and infers an audience's evaluation of each performance piece included in the performance data A. An inference value indicating each evaluation may be a discrete value or a continuous value. The evaluation (evaluation data B) inferred for each performance piece is supplied from the inference processing circuit 155 to the evaluation presentation circuit 156.

At step S650, the evaluation presentation circuit 156 presents the evaluation data B inferred by the inference processing circuit 155 at step S640 to the user. The evaluation data B may be presented to the user in various manners.

An example is an application that simulates and displays a reaction indicated by a virtual audience (for example, an avatar in a virtual reality (VR) space) to a user's performance. In this application, the evaluation presentation circuit 156 causes the input-output circuit 104 to display the reaction indicated by the virtual audience based on the evaluation data B in synchronization with reproduction of the performance data A. At a point of time when the inferred evaluation is higher than a threshold value, the evaluation presentation circuit 156 displays a reaction indicating a high level of enthusiasm such as standing-up and cheering. At a point of time when the inferred evaluation is lower than the threshold value, the evaluation presentation circuit 156 displays a reaction indicating a low level of enthusiasm such as sitting, silence, and booing.

Another example is an application that objectively displays a user's performance by quantifying and tabulating the performance. In this application, the evaluation presentation circuit 156 causes the input-output circuit 104 to display a waveform representing the performance data A and a graph of a transition of the evaluation data B with respect to the performance data A.

It is to be noted that the inference display processing performed at the above-described steps S610 to S650 may be performed in a real-time manner in parallel with the input of the performance data A into the information processing apparatus 100, or may be performed later with respect to the performance data A stored in the information processing apparatus 100.

Thus, the information processing system S according to this embodiment appropriately infers, using the trained model M, an evaluation of each of the plurality of performance pieces included in the performance data A. The information processing apparatus 100 presents the inferred evaluation of each performance piece to the user. As a result, the user is able to predict how the user's performance will be evaluated by the audience.

### Modifications

The above embodiments may be modified in various manners, some of which will be described below. At least one of the following modifications may be selected and combined with the above-described embodiment insofar as no contradiction occurs.

In the above-described embodiment, the performance data A includes a plurality of performance pieces divided in a time-series manner, and the plurality of performance pieces are used in the training processing and the inference processing. The performance data A may not necessarily be divided; the performance data A may correspond to one piece of music.

In the above-described embodiment, various techniques may be used to divide the performance data A. For example, the plurality of performance pieces of the performance data A may be a plurality of performance time-sections obtained by dividing a piece of music at predetermined time intervals. For further example, the plurality of performance pieces of the performance data A may be a plurality of phrases specified based on the performance data A.

In the above-described embodiment, the evaluation data B is subjective data indicating an evaluation value given by a viewer to a performer's performance indicated in the distribution data. Any other information may be used as the evaluation data B.

An example of the evaluation data B is posting data indicating the number of viewer posts regarding a performer's performance. For example, the posting data can be pieces of text information each correlated with a moving image piece included in a moving image. The posting data is included in the distribution data, and the number of posts is counted for each performance piece.

Another example of the evaluation data B is reaction data indicating the audience's actions made in response to the performance. The reaction data is information indicating features associated with the audience's movements made in response to the performance. The data obtaining circuit 252 may obtain the reaction data by analyzing a video of the audience displayed in a music performance moving image included in the distribution data. The video of the audience in the music performance moving image corresponds to a time period in which the audience is displayed. For example, the reaction data can be data obtained by obtaining, in a time series manner, a skeleton of each person of the audience. For further example, the reaction data can be data indicating a magnitude of the movement of the entire audience. For further example, the reaction data can be data indicating a facial expression of each person of the audience. For further example, the reaction data can be data indicating the body temperature of the audience or each person of the audience obtained using, for example, an infrared camera.

In the above-described embodiment, the evaluation presentation circuit 156 visually presents the evaluation data B to the user. Instead of or in addition to the evaluation presentation circuit 156 presenting the evaluation data B, the control section 150 may present video effect candidates for a moving image indicated by the performance data A so as to improve the inferred evaluation. For example, when a plurality of cameras are used to capture a moving image, a video effect for the moving image can be information indicating a timing of switching a camera angle or a fade-out start/end timing.

In the above-described embodiment, the information processing apparatus 100 infers an evaluation using the trained model M supplied from the training server 200. Each of the processes involved in evaluation inferencing, however, may be performed by any apparatus or device constituting the information processing system S. For example, the training server 200 may pre-process the performance data A supplied from the information processing apparatus 100, and input, as input data, the pre-processed performance data A into the trained model M stored in the storage section 260. In this manner, the training server 200 may infer an evaluation of the performance data A. This modification enables the training server 200 to perform inference processing using the trained model M with the performance data A as input data. This reduces the load of processing on the information processing apparatus 100.

Further, the electronic musical instrument EM according to the above-described embodiment may have the functions of a control section, or a control section may have the functions of the electronic musical instrument EM.

It is to be noted that software control programs for implementing the present disclosure may be stored in a non-transitory computer-readable recording medium, and that the effects of the present disclosure may be achieved by reading the software control programs into any of the above-described apparatus(es), device(s), and/or circuit(s). In this case, the program codes read from the recording medium realize the novel functions of the present disclosure, and the non-transitory computer-readable recording medium storing the program codes constitutes the present disclosure. Further, the program codes may be supplied via a transmission medium. In this case, the program codes themselves constitute the present disclosure. In these cases, the recording medium can be a ROM, a floppy disk, a hard disk, an optical disk, a magneto-optical disk, a CD-ROM, a CD-R, a magnetic tape, or a nonvolatile memory card. The “non-transitory computer-readable recording medium”, as used herein, encompasses a medium that holds a program for a certain period of time. For example, such medium can be a volatile memory (for example, a dynamic random access memory (DRAM)) disposed inside a computer system serving as a server or a client when a program is transmitted via a network such as the Internet or a communication line such as a telephone line.

While an embodiment of the present disclosure and modifications of the embodiment have been described, the embodiment and the modifications are intended as illustrative only and are not intended to limit the scope of the present disclosure. It will be understood that the present disclosure can be embodied in other forms without departing from the scope of the present disclosure, and that other omissions, substitutions, additions, and/or alterations can be made to the embodiment and the modifications. Thus, these embodiment and modifications thereof are intended to be encompassed by the scope of the present disclosure. The scope of the present invention accordingly is to be defined as set forth in the appended claims.

What is claimed is:

1. A computer-implemented method comprising:
obtaining a trained model trained to store a relationship between first performance data and first evaluation data, the first performance data indicating a performance performed by a performer, the first evaluation data indicating a first evaluation of the performance, the first evaluation having been made by an audience who has received the performance;
obtaining second performance data;
processing the second performance data using the trained model to make an inference of a second evaluation of the second performance data; and
outputting second evaluation data indicating the inference of the second evaluation.

2. The method according to claim 1,
wherein the first performance data comprises a series of divided performance pieces, and
wherein the first evaluation data comprises a plurality of evaluation pieces each correlated with one of the series of divided performance pieces.

3. The method according to claim 2, wherein the first evaluation data includes at least one of:
subjective data indicating the first evaluation of the performance;
reaction data indicating a reaction of the audience to the performance, and
posting data indicating a number of posts regarding the performance.

4. The method according to 2, further comprising presenting a candidate for a video effect for a moving image indicated by the second performance data, the video effect being for improving the second evaluation indicated by the second evaluation data.

5. The method according to claim 1, wherein the first performance data comprises at least one of sound data indicating a performed sound, video data indicating a video of a player in the performance, and operation data indicating a performance operation made by the player in the performance.

6. The method according to claim 5, wherein the first evaluation data includes at least one of:
subjective data indicating the first evaluation of the performance;
reaction data indicating a reaction of the audience to the performance, and
posting data indicating a number of posts regarding the performance.

7. The method according to claim 5, further comprising presenting a candidate for a video effect for a moving image indicated by the second performance data, the video effect being for improving the second evaluation indicated by the second evaluation data.

8. The method according to claim 5, wherein the video data comprises motion data indicating a feature of a motion of the performer in the performance.

9. The method according to claim 8, wherein the first evaluation data includes at least one of:
subjective data indicating the first evaluation of the performance;
reaction data indicating a reaction of the audience to the performance, and
posting data indicating a number of posts regarding the performance.

10. The method according to claim 8, further comprising presenting a candidate for a video effect for a moving image indicated by the second performance data, the video effect being for improving the second evaluation indicated by the second evaluation data.

11. The method according to claim 1, wherein the first evaluation data includes at least one of:
subjective data indicating the first evaluation of the performance;
reaction data indicating a reaction of the audience to the performance, and
posting data indicating a number of posts regarding the performance.

12. The method according to claim 11, further comprising presenting a candidate for a video effect for a moving image indicated by the second performance data, the video effect being for improving the second evaluation indicated by the second evaluation data.

13. The method according to claim 1, further comprising presenting a candidate for a video effect for a moving image indicated by the second performance data, the video effect being for improving the second evaluation indicated by the second evaluation data.

14. A system comprising:
a memory storing a program; and
at least one processor configured to execute the program stored in the memory to:
obtain a trained model trained to store a relationship between first performance data and first evaluation data, the first performance data indicating a performance performed by a performer, the first evaluation data indicating a first evaluation of the performance, the first evaluation having been made by an audience who has received the performance;
obtain second performance data;
process the second performance data using the trained model to make an inference of a second evaluation of the second performance data; and
output second evaluation data indicating the inference of the second evaluation.

15. The system according to claim 14,
wherein the first performance data comprises a series of divided performance pieces, and
wherein the first evaluation data comprises a plurality of evaluation pieces each correlated with one of the series of divided performance pieces.

16. The system according to claim 14, wherein the first performance data comprises at least one of sound data indicating a performed sound, video data indicating a video of a player in the performance, and operation data indicating a performance operation made by the player in the performance.

17. The system according to claim 16, wherein the video data comprises motion data indicating a feature of a motion of the performer in the performance.

18. The system according to claim 14, wherein the first evaluation data includes at least one of:
subjective data indicating the first evaluation of the performance;
reaction data indicating a reaction of the audience to the performance, and
posting data indicating a number of posts regarding the performance.

19. The system according to claim 14, wherein the at least one processor is configured to execute the program stored in the memory to present a candidate for a video effect for a moving image indicated by the second performance data, the video effect being for improving the second evaluation indicated by the second evaluation data.

20. A non-transitory computer-readable recording medium storing a program that, when executed by at least one computer, causes the at least one computer to perform a method comprising:
obtaining a trained model trained to store a relationship between first performance data and first evaluation data, the first performance data indicating a performance performed by a performer, the first evaluation data indicating a first evaluation of the performance, the first evaluation having been made by an audience who has received the performance;
obtaining second performance data;
processing the second performance data using the trained model to make an inference of a second evaluation of the second performance data; and
outputting second evaluation data indicating the inference of the second evaluation.
